(19) United States
(12) Patent Application Publication
(10) Pub. No.: US 2021/0303254 A1
(43) Pub. Date: Sep. 30, 2021

(54) WIRELESS SPEAKER SYSTEM

(71) Applicant: Beken Corporation, Shanghai (CN)

(72) Inventors: Weifeng Wang, Shanghai (CN); Lulai Chen, Shanghai (CN)

(73) Assignee: Beken Corporation, Shanghai (CN)

(21) Appl. No.: 15/929,516

(22) Filed: May 6, 2020

(30) Foreign Application Priority Data
Mar. 31, 2020 (CN) 202010247215.9

(51) Int. Cl. G06F 3/16; H04R 3/12

(52) U.S. Cl. CPC G06F 3/165; H04W 84/20; H04R 2420/07; H04R 3/12

(57) ABSTRACT

A wireless speaker system includes a first transceiver and a second transceiver. The first transceiver acting as a master is configured to establish a first wireless link with a data source for receiving a plurality of data packets, and to establish a second wireless link with a second transceiver acting as a slave for transmitting a set of parameters to the second transceiver to enable the second transceiver to sniff the plurality of data packets from the data source via an enabled wireless link. The first transceiver is further configured to monitor the values of a first communication quality of the first wireless link and a second communication quality of the enabled wireless link, and to switch roles between the first transceiver and the second transceiver when the first communication quality is less than the second communication quality and the first communication quality decreases to a pre-determined threshold value.

### CROSS REFERENCE TO RELATED APPLICATIONS

This application claims priority to and incorporates by reference Chinese application no. 202010247215.9 filed Mar. 31, 2020.

### TECHNICAL FIELD

The present disclosure generally relates to systems and methods for wireless transmission of data and more particularly, but not exclusively to coordinating the transmission of data between two receiving devices and a transmitting device.

### BACKGROUND

Wireless communication is the transfer of information or power between two or more points that are not connected by an electrical conductor. For wireless technologies using radio waves, the communication distances can be short, such as a few meters for Bluetooth, or it can be as far as millions of kilometers for deep-space radio communications.

One of the problems in some configurations of wireless speaker systems occurs when the main speaker is configured to receive data from a data source and forward the data to another speaker to playback. Because of the unbalanced power consumption between the two speakers, it may result in faster draining of a battery in the main speaker.

Another problem in some configurations is that when the wireless link between the main speaker and the data source is lost due to power outage of the main speaker, or the main speaker is physically disconnected by users, the other speaker needs to reestablish a wireless link with the data source, resulting in delayed data synchronization between the speakers to playback. As a result, users may experience intermittent (“stuttering”) playback or sometimes even silence during audio/video streaming or phone calls. Such a problem may also occur when an object blocks the physical space between the main speaker and the data source.

### SUMMARY

An embodiment provides a system comprising one or more processors of a machine, a memory storing instructions, a data source, a first transceiver and a second transceiver. The first transceiver is configured to acting as a master, establishing a first wireless link with a data source for receiving a plurality of data packets, establishing a second wireless link with a second transceiver acting as a slave for transmitting a set of communication parameters to the second transceiver to enable the second transceiver to sniff the plurality of data packets from the data source via an enabled wireless link, monitoring values of a first communication quality of the first wireless link and a second communication quality of the enabled wireless link, and switching roles between the first transceiver and the second transceiver when the first communication quality is less than the second communication quality and the first communication quality decreases to a pre-determined threshold value.

In an embodiment of the system, the value of first and second communication quality is determined by one or more parameters from a set of quality parameters associated with the first and enabled wireless links.

In an embodiment of the system, the set of quality parameters comprises packets error rate, received signal strength indicator, and signal to noise ratio.

In an embodiment of the system, the first transceiver is further configured to transmit a most recent set of communication parameters before the role switch between the first and second transceivers.

In an embodiment of the system, prior to establishing the first wireless link, the first transceiver is selected based on a higher value in a battery level between a first speaker and a second speaker.

In an embodiment of the system, further comprising, monitoring a battery level of a first speaker coupled with the first transceiver and a second speaker coupled with the second transceiver, switching roles between the first transceiver and the second transceiver when the battery level of one of the first and second speakers acting as the master is lower than the other speaker acting as the slave, and a difference in the battery level between the first and second speakers reaches a second pre-determined threshold value.

In an embodiment of the system, the second wireless link is configured according to a proprietary wireless protocol.

An embodiment provides a system comprising one or more processors of a machine, a memory storing instructions, a data source, a first transceiver and a second transceiver. The system is configured to establishing, by a first transceiver acting as a master, a first wireless link with a data source for receiving a plurality of data packets, and a second wireless link with a second transceiver acting as a slave, monitoring, by the first transceiver, a value of a first communication quality of the first wireless link, switching roles between the first transceiver and the second transceiver when the first communication quality decreases to a pre-determined threshold value, maintaining the switched roles when the value of the communication quality of a post switch first wireless link with the data source is greater than the value of the communication quality of the first wireless link, reverting to previous roles when the value of the communication quality of the post switch first wireless link is less than the value of the communication quality of the first wireless link.

In an embodiment of the system, the value of first and second communication quality are determined by one or more parameters from a set of quality parameters.

In an embodiment of the system, the set of quality parameters comprises packets error rate, received signal strength indicator, and signal to noise ratio.

In an embodiment of the system, the first transceiver is coupled with a first speaker, wherein the first speaker acts as a source and a sink in two piconets simultaneously.

In an embodiment of the system, the second wireless link is configured according to a combination of Bluetooth and proprietary wireless protocols.

In an embodiment of the system, further comprising, monitoring a battery level of a first speaker coupled with the first transceiver and a second speaker coupled with the second transceiver, switching roles between the first transceiver and the second transceiver when the battery level of one of the first and second speakers acting as the master is lower than the other speaker acting as the slave, and a difference in the battery level between the first and second speakers reaches a second pre-determined threshold value.

In an embodiment, a method comprises establishing, by a first speaker acting as a master, a first wireless link with a data source, and a second wireless link with a second speaker acting as a slave; sending, by the first speaker, a set of communication parameters to the second speaker upon losing a connection in the first wireless link; switching roles, by the first speaker, with the second speaker; establishing, by the second speaker, a new wireless link with the data source.

In an embodiment of the method, the set of communication parameters comprises device address, frequency information, communication band information, native clock information, logical transport address, clock offset information and link key information.

In an embodiment of the method, prior to establishing the first wireless link, the first speaker is selected based on a higher value in a battery level between the first and the second speaker.

In an embodiment of the method, the communication parameters comprise device address, frequency information, communication band information, native clock information, logical transport address, clock offset information and link key information.

In an embodiment of the method, wherein first and second speakers delay playback during the role switch to ensure an undisturbed audio streaming.

In an embodiment of the method, the undisturbed audio streaming during role switch is achieved by acoustic repair.

In an embodiment of the method, the undisturbed audio streaming during role switch is achieved by data retransmission from the data source.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a block diagram of a wireless speaker system implemented according to an embodiment before a role switch.

FIG. 2 is a block diagram of a wireless speaker system implemented according to an embodiment after a role switch.

FIG. 3 is a block diagram of a wireless speaker system implemented according to another embodiment before a role switch.

FIG. 4 is a block diagram of a wireless speaker system implemented according to another embodiment after a role switch.

FIG. 5 is a sequence diagram of a role switch in a wireless speaker system implemented according to an embodiment.

FIG. 6 is a sequence diagram of a role switch in a wireless speaker system implemented according to another embodiment.

FIG. 7 is a diagrammatic representation of a processing environment in the first speaker, in accordance with some example embodiments.

FIG. 8 a diagrammatic representation of a processing environment in the second speaker, in accordance with some example embodiments.

FIG. 9 is a flow diagram illustrating a method of operating a wireless speaker system according to an embodiment.

FIG. 10 is a block diagram illustrating a representative software architecture, which may be used in conjunction with various hardware architectures herein described.

FIG. 11 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Various aspects and examples will now be described. The following description provides specific details for a thorough understanding and enabling description of these examples. Those skilled in the art will understand, however, that the disclosure may be practiced without many of these details.

Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples. Certain terms may even be emphasized below, however, any terminology intended to be interpreted in any restricted manner will be overtly and specifically defined as such in the Glossary section.

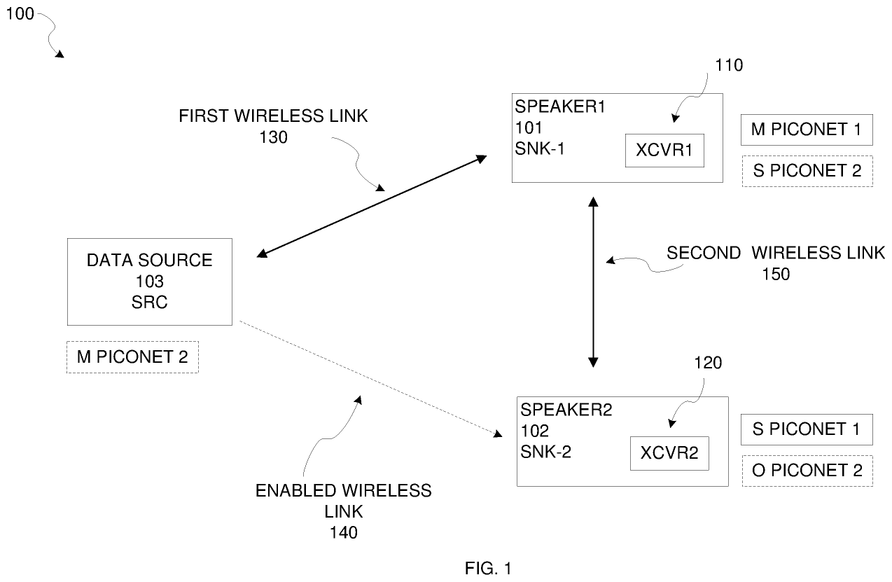

FIG. 1 is a block diagram of a wireless speaker system 100 implemented according to an embodiment using Bluetooth Audio Distribution Profile (A2DP) for wireless communication before a role switch. A2DP profile defines a device as Source (SRC) when it acts as a source of a digital audio stream that is delivered to the SNK of the piconet and defines a device as the Sink (SNK) when it acts as a sink of digital audio stream delivered from the SRC on the same piconet. In an embodiment using Bluetooth A2DP as the wireless communication method, the wireless speaker system includes a data source 103 configured as SRC, a first speaker 101 configured as SNK1, and a second speaker 102 configured as SNK2. The second wireless link 150 is implemented as a first Bluetooth piconet PICONET1, or as a combination of a first Bluetooth piconet PICONET1 and a proprietary wireless communication protocol link, or as a proprietary wireless communication protocol link alone. The first wireless link 130 is implemented as a second Bluetooth piconet PICONET2, or as a combination of a second Bluetooth piconet PICONET2 and a proprietary wireless communication link, or as a proprietary wireless communication link alone. The proprietary wireless communication link may operate on the same channel as PICONET1 or PICONET2, or it may operate on a different channel.

In an embodiment, in PICONET1, the first speaker 101 as SNK1 is the master (M), and the second speaker 102 as SNK2 is the slave (S). In PICONET2, the data source 103 as the SRC is the master (M), the first speaker 101 as SNK1 is a slave (S), and the second speaker 102 as SNK2 is an observer (0). Because SNK1 and SNK2 participate in two piconets simultaneously, the wireless speaker system can support scatternet operation.

In an embodiment, SNK1 is the speaker that is the first to be switched on, such as being physically taken out of a charging station. In another embodiment, the first speaker is the speaker with higher battery level, determined and negotiated by both speakers immediately upon switching on.

In an embodiment, after the SNK1 101 is connected to SRC 103 via the PICONET2, SNK1 101 sends a set of parameters to SNK2 via PICONET1 to enable the SNK2 as the observer to sniff communication on PICONET2. Those skilled in the art shall appreciate that SNK2 102 may be configured to sniff via the enabled wireless link 140 the data packets transmitted in the first wireless link 130 upon receiving the set of communication parameters from SNK1 101. After SNK2 obtains the data packets via sniffing, it can decrypt the data packets at least with the link key if the data packets were encrypted and utilize the decrypted data packets for playback in conjunction with the rest of the communication parameters it received from SNK1 101. The communication parameter may include but are not limited to device address, Bluetooth address, hopping frequency, data transmission rates, codec format, bitpool value, sample rate, wireless transmission profile information, native clock value, logical transport address, clock offset value and link key value.

In an embodiment, the wireless speaker system may be implemented according to other protocol such as WIFI or other Bluetooth profiles such as Hands-free profile (HFP), Serial Port Profile (SPP), etc.

In an embodiment, the first speaker SNK1 101 includes a first transceiver (XCVR1) 110, and the second speaker SNK2 102 includes a second transceiver (XCVR2) 120. The first and second speakers may include but are not limited to loudspeakers which receive audio signals using radiofrequency waves rather than audio cables, such as earpiece, earbuds, earphones, headset, headphones, smart speakers, or devices that include speakers, such as mobile phones, laptops, etc.

In an embodiment, the transceiver of one of the speakers, such as the first transceiver 110 is configured to establish a first wireless link 130 implemented as the PICONET2 with the data source 103. The transceiver of one of the speakers, such as the first transceiver 110 is configured to establish a second wireless link 150 implemented as the PICONET1 with the second transceiver 120. In one embodiment, the second wireless link 150 may be configured at manufacture to permanently pair the first transceiver 110 and the second transceiver 120 and have the second wireless link 150 while powered up.

In an embodiment, the first transceiver 110 dynamically monitors the communication quality in the first wireless link 130, while the second transceiver 120 dynamically monitors the communication quality in the enabled wireless link 140. The first and second transceivers communicate in real-time to compare such parameters and determine if a master-slave role switch in PICONET1 shall be performed. A master-slave role switch is performed when the communication quality in the first wireless link 130 is lower than the communication quality in the enabled wireless link 140 and decreases to a pre-determined threshold value. The communication quality is determined by one or more parameters from a set of quality parameters, including but not limited to packets error rate, received signal strength indicator, and signal to noise ratio. In a piconet, a master device determines the communication characteristics such as hopping frequency of the piconet. A switch of roles between master and slave may result in a reversal of TX and RX timing (i.e. a TDD switch) and a redefinition of the piconet.

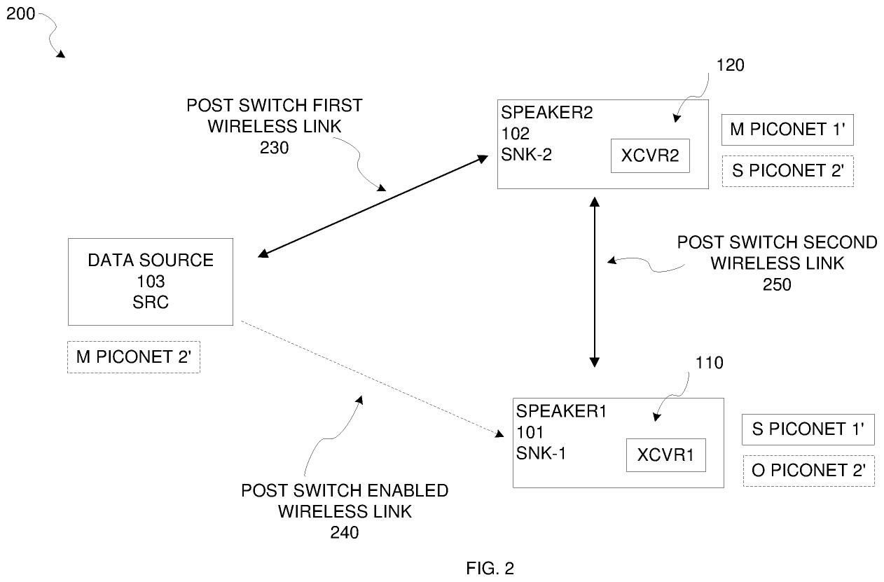

FIG. 2 is a block diagram 200 of a wireless speaker system 200 implemented according to an embodiment using Bluetooth Audio Distribution Profile (A2DP) for wireless communication after a role switch. After the master-slave role switch, in the post switch second wireless link 250 implemented as PICONET1′, the second speaker SNK2 becomes the master (M) and the first speaker becomes the slave (S). In the post switch first wireless link 230 implemented as PICONET2′, the data source remains as the master, the second speaker becomes the slave, and the first speaker becomes the observer (0).

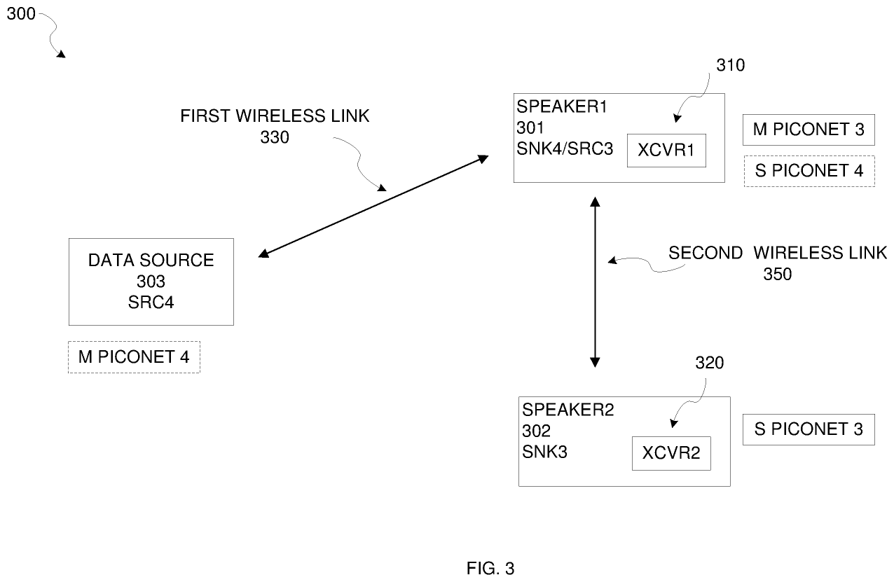

FIG. 3 is a block diagram 300 of a wireless speaker system implemented according to an embodiment using Bluetooth Audio Distribution Profile (A2DP) for wireless communication according to another embodiment before a role switch.

In an embodiment using Bluetooth A2DP as the wireless communication method, the wireless speaker system includes a data source 303 configured as SRC4 in a fourth Bluetooth piconet PICONET4, a first speaker 301 configured as both SNK4 in PICONET4 and as SRC3 in a third Bluetooth piconet PICONET3, and a second speaker 302 configured as SNK3 in PICONET3. The second wireless link 350 is implemented as PICONET3, or as a combination of PICONET3 and a proprietary wireless communication protocol link, or as a proprietary wireless communication protocol link alone. The first wireless link 330 is implemented as the PICONET4, or as a combination of PICONET4 and a proprietary wireless communication protocol link, or as a proprietary wireless communication protocol link alone. The proprietary wireless communication protocol link may operate on the same channel as PICONET3 or PICONET4, or it may operate on a different channel.

In an embodiment, in PICONET3, the first speaker 301 as SRC3 is the master (M), and the second speaker 302 as SNK3 is the slave (S). In PICONET4, the data source 303 as the SRC4 is the master (M), and the first speaker 301 as SNK4 is the slave (S). Because the first speaker as SNK4/SRC3 participates in two piconets simultaneously, the wireless speaker system can support scatternet operation. In an embodiment, second speaker 302 relies solely on the first speaker 301 to receive data packets to playback.

In an embodiment, the first speaker is the speaker first to be switched on, such as being physically taken out of a charging station. In another embodiment, the first speaker is the speaker with higher battery level, determined and negotiated by both speakers immediately upon switching on.

In an embodiment, the first speaker 301 includes a first transceiver (XCVR1) 310, and the second speaker 302 includes a second transceiver (XCVR2) 320. The first transceiver 310 dynamically monitors the communication quality in the first wireless link 330 implemented as PICONET4. The first transceiver determines if a master-slave role switch in PICONET3 shall be performed when the communication quality in the first wireless link 330 decreases to a pre-determined threshold value. The communication quality is determined by one or more quality parameters from a set of quality parameters, including but not limited to packets error rate, received signal strength indicator, and signal to noise ratio.

In an embodiment, the wireless speaker system may be implemented according to other protocol such as WIFI or other Bluetooth profiles such as Hands-free profile (HFP), Serial Port Profile (SPP), etc.

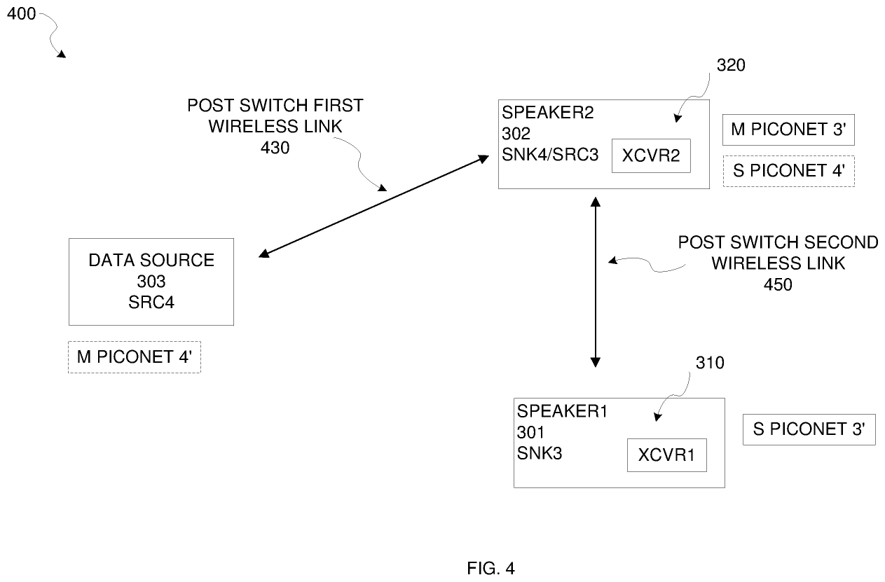

FIG. 4 is a block diagram 400 of a wireless speaker system implemented according to an embodiment using Bluetooth Audio Distribution Profile (A2DP) for wireless communication after a role switch. After the master-slave role switch, in the post switch second wireless link 450 implemented as PICONET3′, the second speaker becomes the master (M) and the first speaker becomes the slave (S). In the post switch first wireless link 430 implemented as PICONET4′, the data source remains as the master (M), the second speaker becomes the slave (S).

In an embodiment, after the master-slave role switch is performed, the second speaker immediately assesses the communication quality of the post switch first wireless link 430 and compares it to the communication quality of the first wireless link 330 prior to the switch. If the communication quality of the post switch first wireless link 430 is greater than the communication quality of the first wireless link 330, the switched roles are maintained. Otherwise, the switch is reversed back to the configurations shown as in FIG. 3.

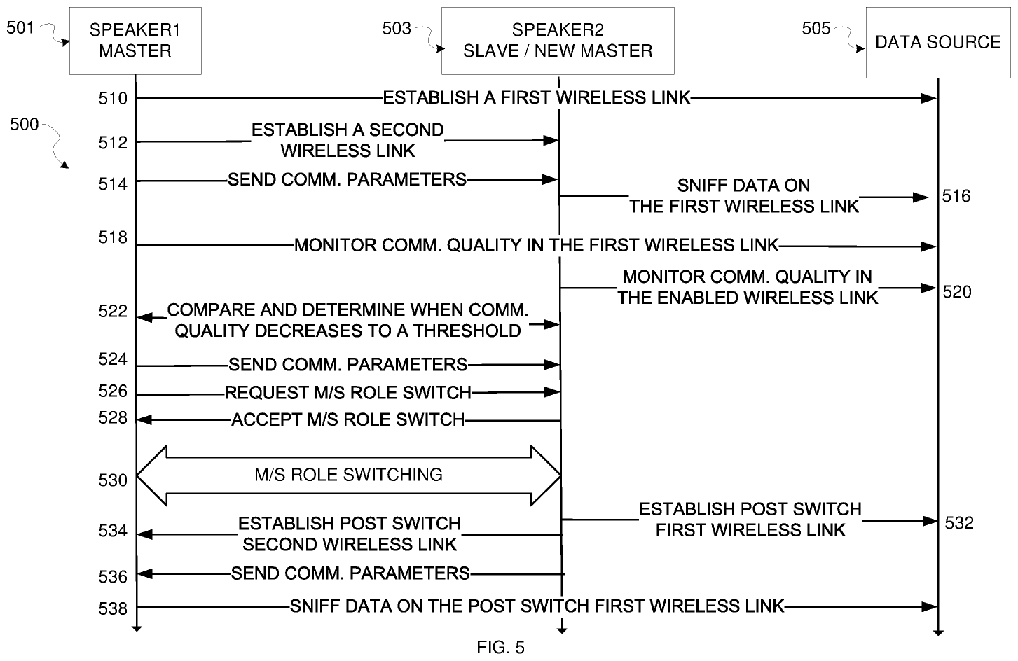

FIG. 5 a sequence diagram 500 of a master-slave role switch in a wireless speaker system implemented according to an embodiment according to the configuration in FIG. 1 and FIG. 2. In an embodiment, the first speaker communicatively couples to the data source via the first wireless link 130, and the second speaker communicatively couples to the first speaker via the second wireless link 150 and sniffs communication between the first speaker and the data source on the first wireless link 130. Those skilled in the art will appreciate that although the specific example in FIG. 5 shows that the first speaker is the master and the second speaker is the slave before the role switch, the first speaker may be the slave while the second speaker is the master before the role switch, as the master-slave role switch is dynamically determined based on the communication qualities in the first wireless link 130 and the enabled wireless link 140.

In operation 510, the first speaker 501 establishes a first wireless link with the data source 505. In operation 512, the first speaker 501 establishes a second wireless link with the second speaker 503. In an embodiment, the second wireless link is configured at manufacture to pair the first speaker 501 and the second speaker 503, that the second wireless link is established while the two speakers are powered up. In operation 514, the first speaker 501 sends communication parameters to the second speaker 503. In operation 516, the second speaker 503 sniffs data on the first wireless link between the data source 505 and the first speaker 501. In operation 518, the first speaker 501 monitors the communication quality in the first wireless link. In operation 520, the second speaker 503 monitors communication in the enabled wireless link between the second speaker 503 and the data source 505. Those skilled in the art will appreciate that operation 518 and operation 520 may occur in any order or may occur simultaneously.

In operation 522, the first speaker and the second speaker compare and determine when the communication quality in the first wireless link is less than the communication quality in the enabled wireless link, and the communication quality in the first wireless link decreases below a threshold value. When the condition in operation 522 is met, in operation 524, the first speaker 501 sends communication parameters to the second speaker 503. In operation 526, the first speaker 501 requests a master-slave (M/S) role switch from the second speaker 503. In operation 528, the second speaker accepts the M/S role switch requested by the first speaker 501. In operation 530, M/S role switch is performed, that the first speaker 501 sends its own TX/RX timing and the mode of operation to the second speaker 503. The second speaker 503 then immediately adjusts its own configuration according to the first speaker's TX/RX timing and the mode of operation. In operation 534, the second speaker 503 as the new master establishes the post switch first wireless link with the data source 505. In operation 534, the second speaker 503 as the new master establishes the post switch second wireless link with the first speaker 501. In operation 536, the second speaker 503 as the new master sends communication parameters to the first speaker 501 as the new slave. In operation 538, the first speaker 501 as the new slave sniffs data on the post switch first wireless link between the data source 505 and the second speaker 503 as the new master.

In an embodiment of 500, after the first and second wireless links are established, the first speaker 501 monitors its own battery level, and the second speaker 503 monitors its own battery level. When the battery level of one of the first and second speakers acting as the master is lower than the other speaker acting as the slave, and the difference in the battery levels between the first and the second speakers exceeds a second pre-determined threshold, a M/S role switch is performed between the two speakers.

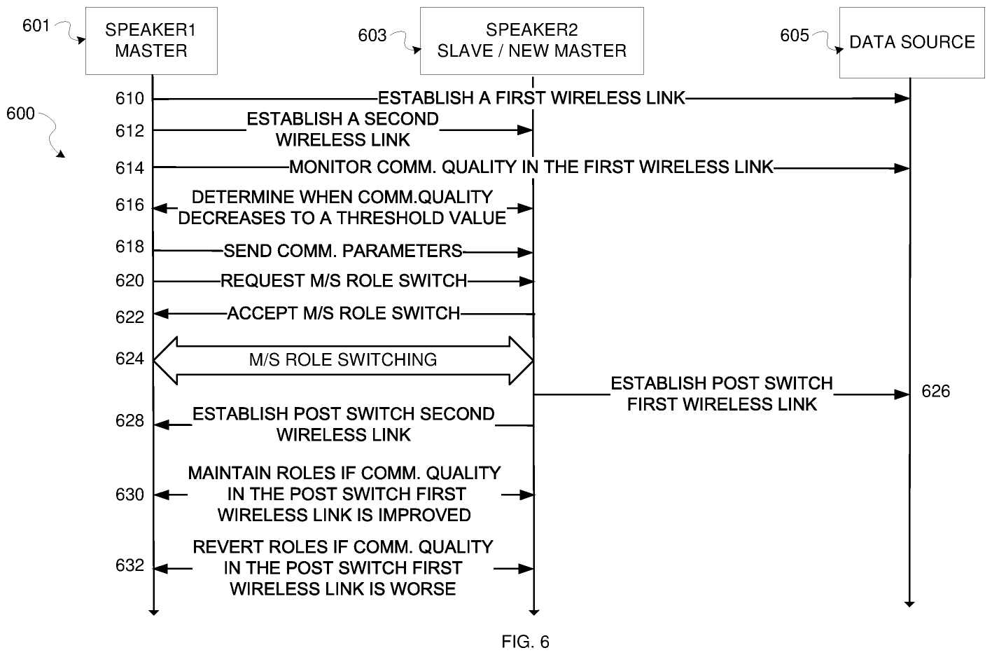

FIG. 6 a sequence diagram 600 of a master-slave role switch in a wireless speaker system implemented according to another embodiment according to the configuration in FIG. 3 and FIG. 4. In an embodiment, the first speaker 301 communicatively couples to the data source via the first wireless link 330, and the second speaker 302 communicatively couples to the first speaker via the second wireless link 350. Those skilled in the art will appreciate that although the specific example in FIG. 6 shows that the first speaker is the master and the second speaker is the slave before the role switch, the first speaker may be the slave while the second speaker is the master before the role switch, as the master-slave role switch is dynamically determined based on the communication quality in the first wireless link 330.

In operation 610, the first speaker 601 establishes a first wireless link with the data source 605. In operation 612, the first speaker establishes a second wireless link with the second speaker 603. In an embodiment, the second wireless link is configured at manufacture to pair the first speaker 601 and the second speaker 603, that the second wireless link is established while the two speakers are powered up.

In operation 614, the first speaker 601 monitors communication quality in the first wireless link. In operation 616, the first speaker 601 determines when the communication quality of the first wireless link decreases to a threshold value. When the condition is met in the operation 616, in operation 618, the first speaker 601 sends communication parameters to the second speaker 603. In operation 620, the first speaker 601 requests the master-slave (M/S) role switch from the second speaker 603. In operation 622, the second speaker 603 accepts the request to perform an M/S role switch. In operation 624, the M/S role switch is performed, that the first speaker 601 sends its own TX/RX timing and the mode of operation to the second speaker 603. The second speaker 603 then immediately adjusts its configuration according to the received TX/RX timing and the mode of operation. In operation 626, the second speaker 603 as the new master establishes the post switch first wireless link with the data source 605. In operation 628, the second speaker 603 as the new master establishes the post switch second wireless link with the first speaker 601 as the new slave. In operation 630, the second speaker 603 as the new master maintains the switched roles if the communication quality in the post switch first wireless link is better than the first wireless link before the switch. In operation 632, the second speaker 603 as the new master reverts the switched roles if the communication quality in the post switch first wireless link is worse than the first wireless link before the switch.

In an embodiment of 600, after the first and second wireless links are established, the first speaker 601 monitors its own battery level, and the second speaker 603 monitors its own battery level. When the battery level of one of the first and second speakers acting as the master is lower than the other speaker acting as the slave, and the difference in the battery levels between the first and the second speakers exceeds a second pre-determined threshold, a M/S role switch is performed between the two speakers.

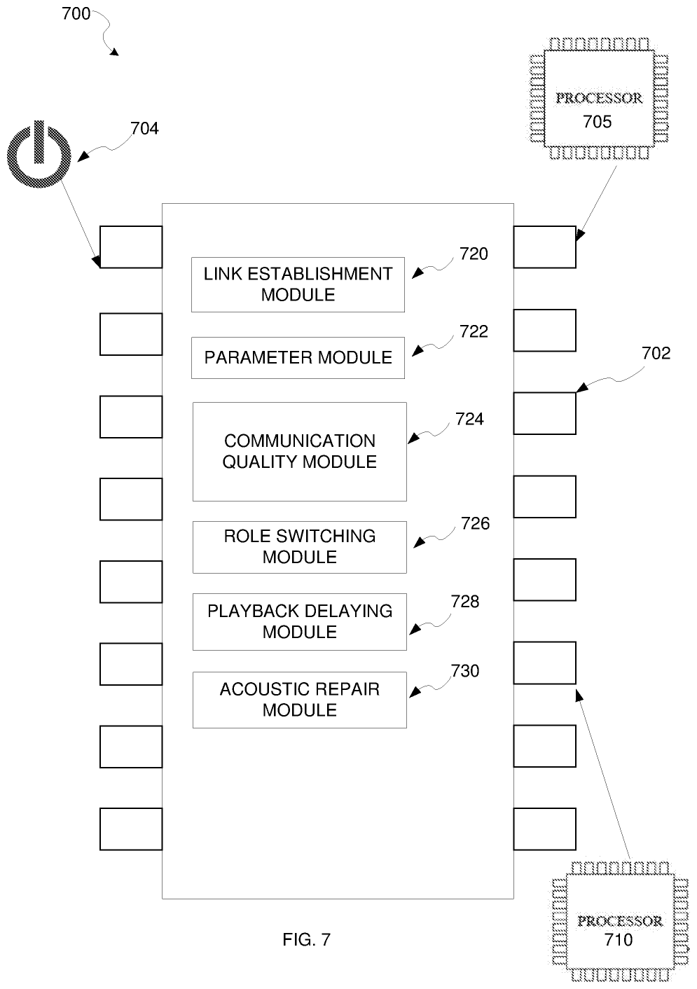

FIG. 7 a diagrammatic representation of a processing environment 700 in the first speaker 101, 301, in accordance with some example embodiments. A diagrammatic representation of a processing environment 700 includes the processor 705, the processor 710, and a processor 702 (e.g., a GPU, CPU or combination thereof).

In an embodiment, the processor 702 in the first speaker 101, 301 is shown to be coupled to a power source 704, and to include (either permanently configured or temporarily instantiated) modules, namely a link establishment module 720, a parameter module 722, a communication quality module 724, an role switching module 726, a playback delay module 728, and an acoustic repair module 730.

In an embodiment such as the configuration shown in FIG. 1 and FIG. 2, the link establishment module 720 operationally establishes a first wireless link 130 with a data source 103 and establishes a second wireless link 150 with a second transceiver 120 that is communicatively coupled to a second speaker 102. The parameter module 722 operationally generates a set of communication parameters and transmits the set of communication parameters to the second transceiver 120 to enable the second transceiver 120 to sniff the data communication on the first wireless link 130. The communication quality module 724 operationally monitors the communication quality of the first wireless link 130. The role switching module 726 operationally switches the master-slave roles of the first speaker 101 and the second speaker 102 when the communication quality of the first wireless link 130 is less than the communication quality of the enabled wireless link 140 and decreases to the pre-determined threshold value. Once the role switch condition is met, the parameter module 722 operationally generates a set of communication parameters and transmits the set of communication parameters to the second transceiver 120, and the role switching module 726 operationally sends its own TX/RX timing and the mode of operation to the second transceiver 120. As results of the role switch, the first speaker 101 becomes the new slave, and the second speaker 102 becomes the new master in PICONET1′ as shown in FIG. 2. The link establishment module 720 operationally establishes the post switch first wireless link 230 with the data source 103 and establish the post switch second wireless link 250 with the first transceiver 110.

In an embodiment such as the configuration shown in FIG. 3 and FIG. 4, the link establishment module 720 operationally establishes a first wireless link 330 with a data source 303 and establishes a second wireless link 350 with a second transceiver 320 that is communicatively coupled to a second speaker 302. The communication quality module 724 operationally monitors the communication quality of the first wireless link 330 and decides on the master-slave role switch when the communication quality of the first wireless link 330 decreases to a pre-determined threshold value. When the role switch condition is met, the parameter module 722 operationally generates a set of communication parameters and sends to the second transceiver 320, and the role switching module 726 operationally sends its own TX/RX timing and the mode of operation to the second transceiver 320 coupled to the second speaker 302. As results of the role switch, the first speaker 301 becomes the new slave, and the second speaker 302 becomes the new master in PICONET3′ as shown in FIG. 4. The link establishment module 720 operationally establishes the post switch first wireless link 430 with the data source 303 and establish the post switch second wireless link 450 with the first transceiver 310. The communication quality module 724 operationally monitors the communication quality of the post switch first wireless link 430, and determines that if the value of the communication quality of the post switch first wireless link 430 is greater than the communication quality of the first wireless link 330 before the switch, the switched roles are maintained. If the value of the communication quality of the post switch first wireless link 430 is less than the communication quality of the first wireless link 330 before the switch, the switched roles are reversed. The reversion of the roles adopts the same signal transmission scheme as the role switch disclosed herein.

The playback delaying module 728 operationally delays the playback in the first speaker until the timing synchronization between the first and second speakers during role switch is complete. The acoustic repair module 730 operationally adopts a packet loss concealment method (PLC) to mask the effect of packet loss during role switch, including but not limited to zero insertion where the lost speech frames are replaced with zero, the waveform substitution where the missing gap is reconstructed by repeating a portion of already received speech. The simplest form of this would be to repeat the last received frame, and the model-based method, where methods of interpolating and extrapolating speech gaps are adopted.

In an embodiment of 700, a battery level detection module (not shown) operationally detects the battery level in the first speaker 101, 301. When the battery level of one of the first and second speakers acting as the master is lower than the other speaker acting as the slave, and the difference in the battery levels between the first and the second speakers exceeds a second pre-determined threshold, a M/S role switch is performed between the first and second speakers.

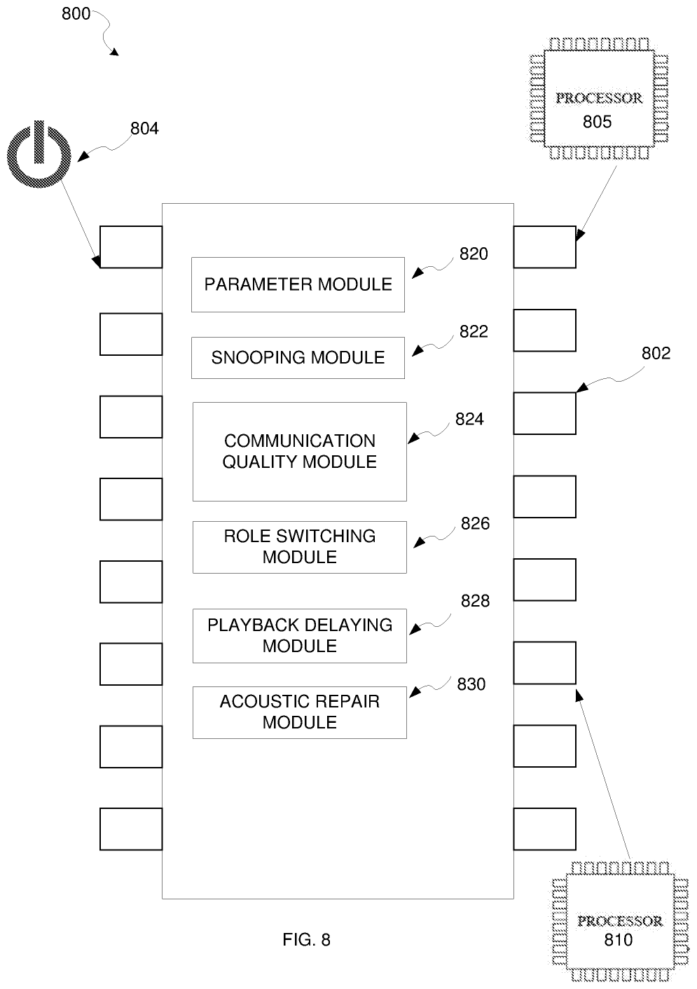

FIG. 8 is a diagrammatic representation of a processing environment 800 in the second speaker 102, 302, in accordance with some example embodiments. A diagrammatic representation of a processing environment 800 includes the processor 805, the processor 810, and a processor 802 (e.g., a GPU, CPU or combination thereof).

In an embodiment, the processor 802 in the second speaker 102, 302 is shown to be coupled to a power source 804, and to include (either permanently configured or temporarily instantiated) modules, namely a parameter module 820, a snooping module 822, a communication quality module 824, an role switching module 826, a playback delay module 828, and an acoustic repair module 830.

In an embodiment such as the configuration shown in FIG. 1 and FIG. 2, the parameter module 820 operationally receives the communication parameter from the first transceiver 110. The snooping module 822 operationally sniffs data transmission on the first wireless link 130. The communication quality module 824 operationally monitors the communication quality on the enabled wireless link 140. The role switching module 826 operationally adjusts its own configuration according to the first speaker's TX/RX timing and the mode of operation.

In an embodiment such as the configuration shown in FIG. 3 and FIG. 4, the parameter module 820 operationally receives the communication parameter from the first transceiver 310. The role switching module 826 operationally adjusts the configuration of the second speaker according to the first speaker's TX/RX timing and the mode of operation.

According to some embodiments, the playback delaying module 828 operationally delays the playback in the second speaker until the timing synchronization between the first and second speakers during role switch is complete. The acoustic repair module 830 operationally adopts a packet loss concealment method (PLC) to mask the effect of packet loss during role switch, including but not limited to zero insertion where the lost speech frames are replaced with zero, the waveform substitution where the missing gap is reconstructed by repeating a portion of already received speech. The simplest form of this would be to repeat the last received frame, and the model-based method, where methods of interpolating and extrapolating speech gaps are adopted.

In an embodiment of 800, a battery level detection module (not shown) operationally detects the battery level in the second speaker 102, 302. When the battery level of one of the first and second speakers acting as the master is lower than the other speaker acting as the slave, and the difference in the battery levels between the first and the second speakers exceeds a second pre-determined threshold, a M/S role switch is performed between the first and second speakers.

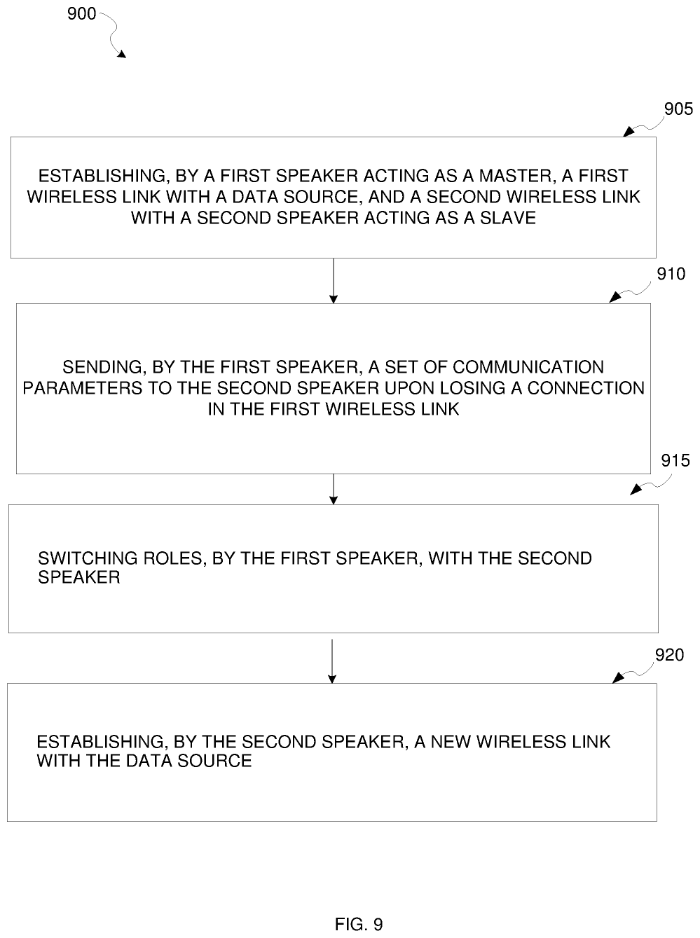

FIG. 9 is a flow diagram 900 illustrating a method of operating a wireless speaker system according to an embodiment. While the various operations in this diagram are presented and described sequentially, one of ordinary skill will appreciate that some or all of the operations may be executed in a different order, be combined or omitted, or be executed in parallel. At operation 905, the first speaker 101, 301 acting as a master establishes a first wireless link 130, 330 with a data source 103, 303, and a second wireless link 150, 350 with a second speaker 102, 302 acting as a slave. At operation 910, the first speaker 101, 301 sends a set of communication parameters to the second speaker 102, 302 upon losing a connection in the first wireless link 130, 330. At operation 915, the first speaker 101, 301 switches roles with the second speaker 102, 302. At operation 920, the second speaker 102, 302 establishes a new wireless link 230, 430 with the data source 103, 303.

### Software Architecture

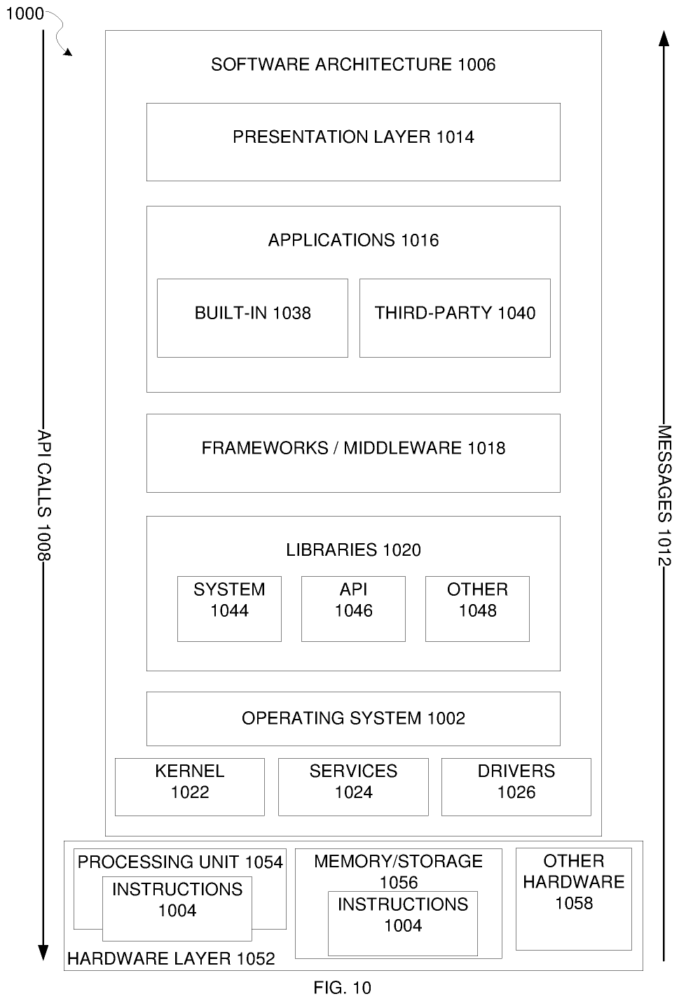

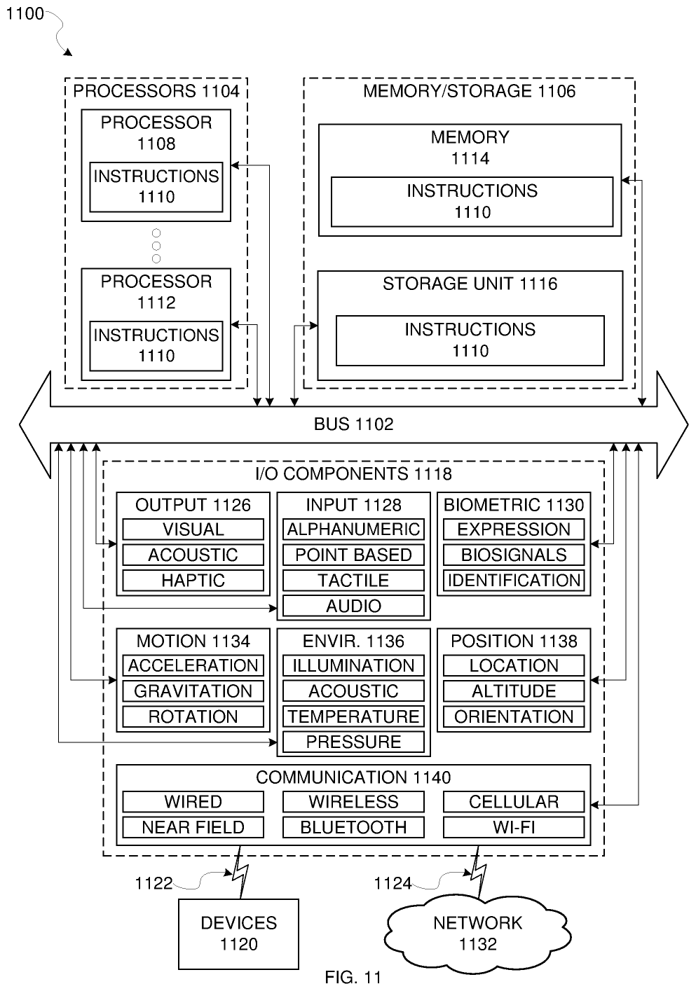

FIG. 10 is a block diagram illustrating an example software architecture 1006, which may be used in conjunction with various hardware architectures herein described, such as the first speaker 101, 301 or the second the speaker 102, 302. FIG. 10 is a non-limiting example of a software architecture 1006 and it will be appreciated that many other architectures may be implemented to facilitate the functionality described herein. The software architecture 1006 may execute on hardware such as machine 1100 of FIG. 11 that includes, among other things, processors 1104, memory 1114, and (input/output) I/O components 1118. A representative hardware layer 1052 is illustrated and can represent, for example, the machine 1100 of FIG. 11. The representative hardware layer 1052 includes a processing unit 1054 having associated executable instructions 1004. Executable instructions 1004 represent the executable instructions of the software architecture 1006, including implementation of the methods, components, and so forth described herein. The hardware layer 1052 also includes memory and/or storage modules memory/storage 1056, which also have executable instructions 1004. The hardware layer 1052 may also comprise other hardware 1058.

In the example architecture of FIG. 10, the software architecture 1006 may be conceptualized as a stack of layers where each layer provides particular functionality. For example, the software architecture 1006 may include layers such as an operating system 1002, libraries 1020, frameworks/middleware 1018, applications 1016, and a presentation layer 1014. Operationally, the applications 1016 and/or other components within the layers may invoke API calls 1008 through the software stack and receive a response such as messages 1012 in response to the API calls 1008. The layers illustrated are representative in nature and not all software architectures have all layers. For example, some mobile or special purpose operating systems may not provide a frameworks/middleware 1018, while others may provide such a layer. Other software architectures may include additional or different layers.

The operating system 1002 may manage hardware resources and provide common services. The operating system 1002 may include, for example, a kernel 1022, services 1024, and drivers 1026. The kernel 1022 may act as an abstraction layer between the hardware and the other software layers. For example, the kernel 1022 may be responsible for memory management, processor management (e.g., scheduling), component management, networking, security settings, and so on. The services 1024 may provide other common services for the other software layers. The drivers 1026 are responsible for controlling or interfacing with the underlying hardware. For instance, the drivers 1026 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 1020 provide a common infrastructure that is used by the applications 1016 and/or other components and/or layers. The libraries 1020 provide functionality that allows other software components to perform tasks in an easier fashion than to interface directly with the underlying operating system 1002 functionality (e.g., kernel 1022, services 1024 and/or drivers 1026). The libraries 1020 may include system libraries 1044 (e.g., C standard library) that may provide functions such as memory allocation functions, string manipulation functions, mathematical functions, and the like. In addition, the libraries 1020 may include API libraries 1046 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1020 may also include a wide variety of other libraries 1048 to provide many other APIs to the applications 1016 and other software components/modules.

The frameworks/middleware 1018 (also sometimes referred to as middleware) provide a higher-level common infrastructure that may be used by the applications 1016 and/or other software components/modules. For example, the frameworks/middleware 1018 may provide various graphic user interface (GUI) functions, high-level resource management, high-level location services, and so forth. The frameworks/middleware 1018 may provide a broad spectrum of other APIs that may be used by the applications 1016 and/or other software components/modules, some of which may be specific to a particular operating system 1002 or platform.

The applications 1016 include built-in applications 1038 and/or third-party applications 1040. Examples of representative built-in applications 1038 may include, but are not limited to, a contacts application, a browser application, a book reader application, a location application, a media application, a messaging application, and/or a game application. Third-party applications 1040 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 1040 may invoke the API calls 1008 provided by the mobile operating system (such as operating system 1002) to facilitate functionality described herein.

The applications 1016 may use built in operating system functions (e.g., kernel 1022, services 1024 and/or drivers 1026), libraries 1020, and frameworks/middleware 1018 to create user interfaces to interact with users of the system. Alternatively, or additionally, in some systems, interactions with a user may occur through a presentation layer, such as presentation layer 1014. In these systems, the application/component “logic” can be separated from the aspects of the application/component that interact with a user.

FIG. 11 is a block diagram illustrating components of a machine 1100, such as the first speaker 101, 301 or the second speaker 102, 302 according to some example embodiments, able to read instructions 1004 from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1110 (e.g., software, a program, an application, an applet, an app, or other executable code) for causing the machine 1100 to perform any one or more of the methodologies discussed herein may be executed. As such, the instructions 1110 may be used to implement modules or components described herein. The instructions 1110 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 1100 capable of executing the instructions 1110, sequentially or otherwise, that specify actions to be taken by machine 1100. Further, while only a single machine 1100 is illustrated, the term “machine” shall also be taken to include a collection of machines that individually or jointly execute the instructions 1110 to perform any one or more of the methodologies discussed herein.

The machine 1100 may include processors 1104, memory/storage 1106, and I/O components 1118, which may be configured to communicate with each other such as via a bus 1102. The memory/storage 1106 may include a memory 1114, such as a main memory, or other memory storage, and a storage unit 1116, both accessible to the processors 1104 such as via the bus 1102. The storage unit 1116 and memory 1114 store the instructions 1110 embodying any one or more of the methodologies or functions described herein. The instructions 1110 may also reside, completely or partially, within the memory 1114, within the storage unit 1116, within at least one of the processors 1104 (e.g., within the processor's cache memory), or any suitable combination thereof, during execution thereof by the machine 1100. Accordingly, the memory 1114, the storage unit 1116, and the memory of processors 1104 are examples of machine-readable media.

The I/O components 1118 may include a wide variety of components to receive input, provide output, produce output, transmit information, exchange information, capture measurements, and so on. The specific I/O components 1118 that are included in a particular machine 1100 will depend on the type of machine. For example, portable machines such as mobile phones will likely include a touch input device or other such input mechanisms, while a headless server machine will likely not include such a touch input device. It will be appreciated that the I/O components 1118 may include many other components that are not shown in FIG. 11. The I/O components 1118 are grouped according to functionality merely for simplifying the following discussion and the grouping is in no way limiting. In various example embodiments, the I/O components 1118 may include output components 1126 and input components 1128. The output components 1126 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1128 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1118 may include biometric components 1130, motion components 1134, environmental components 1136, or position components 1138 among a wide array of other components. For example, the biometric components 1130 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1134 may include acceleration sensor components (e.g., accelerometer), gravitation sensor components, rotation sensor components (e.g., gyroscope), and so forth. The environmental components 1136 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1138 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1118 may include communication components 1140 operable to couple the machine 1100 to a network 1132 or devices 1120 via coupling 1124 and coupling 1122, respectively. For example, the communication components 1140 may include a network interface component or other suitable device to interface with the network 1132. In further examples, communication components 1140 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1120 may be another machine or any of a wide variety of peripheral devices (e.g., a peripheral device coupled via a USB).

Moreover, the communication components 1140 may detect identifiers or include components operable to detect identifiers. For example, the communication components 1140 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1140, such as, location via Internet Protocol (IP) geo-location, location via Wi-Fi® signal triangulation, location via detecting a NFC beacon signal that may indicate a particular location, and so forth.

Features and aspects of various embodiments may be integrated into other embodiments, and embodiments illustrated in this document may be implemented without all of the features or aspects illustrated or described. One skilled in the art will appreciate that although specific examples and embodiments of the system and methods have been described for purposes of illustration, various modifications can be made without deviating from the spirit and scope of the present disclosure. Moreover, features of one embodiment may be incorporated into other embodiments, even where those features are not described together in a single embodiment within the present document. Accordingly, the disclosure is described by the appended claims.

### Glossary

The term “DATA” as used herein refers to audio, video, or monophonic voice information. The term “speaker” includes but not limited to any electro-acoustic transducer, such as home and professional audio speakers and headphones, earphones, earbuds, etc. The term “data source” refers to any electronic device for storing and processing data according to instructions given to it in a variable program, such as computers and mobile devices. Mobile devices may include mobile phone, a portable game player, a portable media player (e.g., MP3 player), or tablet computer, or any piece of portable electronic equipment that can connect to the internet or any wireless network.

The term “STANDARD WIRELESS PROTOCOL” as used herein refers to any open or publicly available wireless protocol or any wireless protocol that is a product of a standards body or special interest group, which includes but is not limited to Bluetooth, Wi-Fi® (based on the IEEE 802.11 family of standards). In order to adopt Bluetooth protocol, a device must be compatible with the subset of Bluetooth profiles. Bluetooth profiles in the context include but not limited to Advanced Audio Distribution Profile (A2DP), Hands-free profile (HFP), Serial Port Profile (SPP), etc. The term “proprietary wireless protocol” as used herein refers to any wireless protocol other than a standard wireless protocol. Bluetooth is a standard protocol for sending and receiving data via a 2.4 GHz wireless link. It's designed for short-range wireless transmission between electronic devices.

“SIGNAL” as used herein refers to any intangible medium that is capable of storing, encoding, or carrying instructions 1110 for execution by the machine 1100, and includes digital or analog communications signals or other intangible medium to facilitate communication of such instructions 1110. Instructions 1110 may be transmitted or received over the network 1132 using a transmission medium via a network interface device and using any one of a number of well-known transfer protocols.

“CLIENT DEVICE” in this context refers to any machine 1100 that interfaces to a communications network 1132 to obtain resources from one or more server systems or other client devices. A client device may be, but is not limited to, a mobile phone, desktop computer, laptop, PDAs, smart phones, tablets, ultra books, netbooks, laptops, multi-processor systems, microprocessor-based or programmable consumer electronics, game consoles, STBs, or any other communication device that a user may use to access a network 1132.

“COMMUNICATIONS NETWORK” in this context refers to one or more portions of a network 1132 that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 1132 or a portion of a network 1132 may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long-range protocols, or other data transfer technology.

“MACHINE-READABLE MEDIUM” in this context refers to a component, device or other tangible media able to store instructions 1110 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 1110. The term “machine-readable medium” shall also be taken to include any medium, or combination of multiple media, that is capable of storing instructions 1110 (e.g., code) for execution by a machine 1100, such that the instructions 1110, when executed by one or more processors 1104 of the machine 1100, cause the machine 1100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 1104) may be configured by software (e.g., an application 816 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 1104 or other programmable processor 1104. Once configured by such software, hardware components become specific machines 1100 (or specific components of a machine 1100) uniquely tailored to perform the configured functions and are no longer general-purpose processors 1104. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 1104 configured by software to become a special-purpose processor, the general-purpose processor 1104 may be configured as respectively different special-purpose processors (e.g., comprising different hardware components) at different times. Software accordingly configures a particular processor or processors 1104, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 1102) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 1104 that are temporarily configured (e.g., by software) or permanently configured to perform the relevant operations. Whether temporarily or permanently configured, such processors 1104 may constitute processor-implemented components that operate to perform one or more operations or functions described herein. As used herein, “processor-implemented component” refers to a hardware component implemented using one or more processors 1104. Similarly, the methods described herein may be at least partially processor-implemented, with a particular processor or processors 1104 being an example of hardware. For example, at least some of the operations of a method may be performed by one or more processors 1104 or processor-implemented components. Moreover, the one or more processors 1104 may also operate to support performance of the relevant operations in a “cloud computing” environment or as a “software as a service” (SaaS). For example, at least some of the operations may be performed by a group of computers (as examples of machines 1100 including processors 1104), with these operations being accessible via a network 1132 (e.g., the Internet) and via one or more appropriate interfaces (e.g., an API). The performance of certain of the operations may be distributed among the processors 1104, not only residing within a single machine 1100, but deployed across a number of machines 1100. In some example embodiments, the processors 1104 or processor-implemented components may be located in a single geographic location (e.g., within a home environment, an office environment, or a server farm). In other example embodiments, the processors 1104 or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine 1100. A processor 1104 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor may further be a multi-core processor having two or more independent processors 1104 (sometimes referred to as “cores”) that may execute instructions 1110 contemporaneously.

1. A system, comprising:
one or more processors of a machine; and
memory storing instructions that, when executed by the one or more processors, cause the machine to perform operations comprising:
establishing, by a first transceiver acting as a master, a first wireless link with a data source for receiving a plurality of data packets;
establishing, by the first transceiver, a second wireless link with a second transceiver acting as a slave for transmitting a set of communication parameters to the second transceiver to enable the second transceiver to sniff the plurality of data packets from the data source via an enabled wireless link, the communication parameters including device address, frequency information, communication band information, native clock information, logical transport address, clock offset information and link key information;
monitoring, by the first transceiver, values of a first communication quality of the first wireless link and a second communication quality of the enabled wireless link; and
switching roles between the first transceiver and the second transceiver when the first communication quality is less than the second communication quality and the first communication quality decreases to a pre-determined threshold value.

2. The system in claim 1, wherein the value of first and second communication quality is determined by one or more parameters from a set of quality parameters associated with the first and enabled wireless links.

3. The system in claim 2, wherein the set of quality parameters comprises packets error rate, received signal strength indicator, and signal to noise ratio.

4. The system in claim 1, wherein the first transceiver is further configured to transmit a most recent set of communication parameters before the role switch between the first and second transceivers.

5. The system in claim 1, wherein prior to establishing the first wireless link, the first transceiver is selected based on a higher value in a battery level between a first speaker and a second speaker.

6. The system in claim 1, further comprising, monitoring a battery level of a first speaker coupled with the first transceiver and a second speaker coupled with the second transceiver, switching roles between the first transceiver and the second transceiver when the battery level of one of the first and second speakers acting as the master is lower than the other speaker acting as the slave, and a difference in the battery level between the first and second speakers reaches a second pre-determined threshold value.

7. The system in claim 1, wherein the second wireless link is configured according to a proprietary wireless protocol.

8. A system, comprising:
one or more processors of a machine; and
memory storing instructions that, when executed by the one or more processors, cause the machine to perform operations comprising:
establishing, by a first transceiver acting as a master, a first wireless link with a data source for receiving a plurality of data packets, and a second wireless link with a second transceiver acting as a slave;
monitoring, by the first transceiver, a value of a first communication quality of the first wireless link;
switching roles between the first transceiver and the second transceiver when the first communication quality decreases to a pre-determined threshold value including transmitting a set of communication parameters to the second transceiver over the second wireless link to enable the second transceiver to sniff a plurality of data packets from the data source via an enabled wireless link, the communication parameters including device address, frequency information, communication band information, native clock information, logical transport address, clock offset information and link key information;
maintaining the switched roles when the value of the communication quality of a post switch first wireless link with the data source is greater than the value of the communication quality of the first wireless link; and
reverting to previous roles when the value of the communication quality of the post switch first wireless link is less than the value of the communication quality of the first wireless link.

9. The system in claim 8, wherein the value of first and second communication quality are determined by one or more parameters from a set of quality parameters.

10. The system in claim 9, wherein the set of quality parameters comprises packets error rate, received signal strength indicator, and signal to noise ratio.

11. The system in claim 8, wherein the first transceiver is coupled with a first speaker, wherein the first speaker acts as a source and a sink in two piconets simultaneously.

12. The system in claim 8, wherein the second wireless link is configured according to a combination of Bluetooth and proprietary wireless protocols.

13. The system in claim 8, further comprising, monitoring a battery level of a first speaker coupled with the first transceiver and a second speaker coupled with the second transceiver, switching roles between the first transceiver and the second transceiver when the battery level of one of the first and second speakers acting as the master is lower than the other speaker acting as the slave, and a difference in the battery level between the first and second speakers reaches a second pre-determined threshold value.

14. A method, comprising:
establishing, by a first speaker acting as a master, a first wireless link with a data source, and a second wireless link with a second speaker acting as a slave;
sending, by the first speaker, a set of communication parameters to the second speaker upon losing a connection in the first wireless link, the communication parameters including device address, frequency information, communication band information, native clock information, logical transport address, clock offset information and link key information;
switching roles, by the first speaker, with the second speaker; and
establishing, by the second speaker, a new wireless link with the data source.

15. The method in claim 14, wherein the set of communication parameters comprises device address, frequency information, communication band information, native clock information, logical transport address, clock offset information and link key information.

16. The method in claim 14, wherein prior to establishing the first wireless link, the first speaker is selected based on a higher value in a battery level between the first and the second speaker.

17. (canceled)

18. The method in claim 14, wherein first and second speakers delay playback during the role switch to ensure an undisturbed audio streaming.

19. The method in claim 18, wherein the undisturbed audio streaming during the role switch is achieved by acoustic repair.

20. The method in claim 18, wherein the undisturbed audio streaming during the role switch is achieved by data retransmission from the data source.

21. The method of claim 14, further comprising using, by the second speaker, the link key information to decrypt data packets transmitted from the data source to the second speaker over the new wireless link.
